(19) United States
(12) Patent Application Publication
(10) Pub. No.: US 2023/0216030 A1
(43) Pub. Date: Jul. 6, 2023

(54) SI-CONTAINING COMPOSITE ANODE FOR ENERGY STORAGE DEVICES

(71) Applicant: FastCAP Systems Corporation, Wakefield, MA (US)

(72) Inventors: Nicolo Brambilla, Brookline, MA (US); Wanjun Ben Cao, Boston, MA (US); Xujie Chen, Quincy, MA (US); Qianran He, Boston, MA (US); Ki Tae Park, Chestnut Hill, MA (US); Jin Yan, Boston, MA (US)

(21) Appl. No.: 17/927,034

(22) PCT Filed: May 24, 2021
(86) PCT No.: PCT/US2021/033856

§ 371 Date: Nov. 22, 2022

Related U.S. Application Data
(60) Provisional application No. 63/028,982, filed on May 22, 2020.

(51) Int. Cl. H01M 4/36; H01M 4/587; H01M 4/38; H01M 4/04

(52) U.S. Cl. CPC H01M 4/366; H01M 4/587; H01M 4/386; H01M 4/0404

(57) ABSTRACT

Disclosed herein is a composition comprising a shell that is substantially carbon encapsulating a volume that contains a nanoform of silicon and a void space. Disclosed herein too is a method of fabricating a composition comprising combining a nanoform of silicon with a carbon precursor and sintering the combination with a laser.

### RELATED REFERENCES

The present application is related to U.S. Patent Application No. 63/028,982, U.S. Pat. No. 10,600,582, entitled “Composite Electrode,” issued on Mar. 24, 2020; U.S. Pat. No. 9,001,495, entitled “High power and high energy electrodes using carbon nanotubes,” issued on Apr. 7, 2015 and also U.S. Pat. No. 9,218,917, entitled “Energy storage media for ultracapacitors,” issued on Dec. 22, 2015, the entire disclosures of which are incorporated by reference herein for any purpose whatsoever.

### BACKGROUND

As the world increasingly moves towards the expanded use of mobile electrical devices, such as vehicles, mobile communication devices, and so called Internet of Things networked sensors and devices, there is an increased need for high performance rechargeable energy storage devices. One avenue for improving the performance of such devices is the use of silicon based anodes in electrochemical cells (e.g., batteries, electric double layer capacitors, and hybrid capacitors. While silicon exhibits excellent charge storage properties, it disadvantageously undergoes significant mechanical swelling when accepting charge. This swelling can cause mechanical failures in an electrode, rendering them unsuitable for use.

Accordingly, there this been interest in using composite structures of carbon and silicon to provide a high-performance electrode with suitable mechanical stability during charging and discharging processing. For example, consider International Patent Application No. PCT/US2019/013261, entitled “Silicon Micro-Reactors for Lithium Rechargeable Batteries,” the entire contents of which is incorporated herein by reference in its entirety. The '261 application discloses a process for fabricating a composite silicon carbon anode. Another example is provided in U.S. Pat. No. 10,340,520, issued Jul. 2, 2019 and entitled “Nanocomposite battery electrode particles with changing properties,” the entire contents of which is incorporated herein in its entirety. The '520 patent discloses silicon containing carbon nanoshell particles for use in electrodes.

However, in many cases, such approaches are not suitable for rapid, low cost manufacture, and may exhibit a number of other disadvantageous features. For example, in some cases electrodes made using these approaches require the inclusion of polymer binders, which reduce the performance of the electrode, and may make it unsuitable for use under operating conditions such as high voltage or high temperature.

There is a continuing need for increased power and energy in energy storage devices such as batteries and capacitors. What are needed are advancements in the physics and chemistry of electrode technology that provide for such improvements.

### SUMMARY OF THE INVENTION

Disclosed The present application discloses, intel alia, a method of fabricating a composite silicon carbon electrode suitable for use, e.g., as an anode in a lithium ion battery.

In general, the processes described herein begin with the production of a precursor material that includes silicon. Examples of precursor materials include carbon coated nanoscopic silicon (e.g. as described in the '261 application), nanoscopic carbon shells surrounding silicon particles (e.g., as described in the '520 patent), or silicon oxide based materials (as described in more detail below). These precursor materials are then incorporated into a high-performance electrode using the techniques described herein. In some embodiments, the high-performance electrode is advantageously free of polymer binders. In some embodiments, the high-performance electrode may be manufactured using a highly efficient roll to roll process featuring a continuing process for converting electrically non-conductive polymeric materials to electrically conductive carbonized material.

In some embodiments, the process includes ball milling micron sized silicon particles to form nano sized silicon particles (i.e., particles having a mean particle size of less than 100 nm, less than 50 nm, less than 10 nm, less than 5 nm, or less than 1 nm, e.g., in the range of 1 nm-100 nm). The nano silicon is then ball milled again in combination with a polymer material such as polyacrylonitrile (PAN), pitch, and the like, to form nano silicon coated in the polymer material. The resulting mixture may then be sintered by applying heat to elevate the temperature of the mixture above a carbonization threshold temperature of the polymer material, causing the polymer to convert to a carbon coating on the silicon particles.

The resulting material may then be etched (e.g., using a chemical etchant, washed and then vacuum dried. The resulting material will be silicon nanoparticles coated in carbon which features internal voids.

This material may then be mixed with a solvent and a polymer binder to form a slurry. The resulting slurry may then be coated onto a substrate (e.g., a conductive foil) use coating process such as slot die coating, comma coating, doctor blade coating, or any other suitable technique. The coated layer may later be dried (e.g., by applying heat in an oven, such as an oven featuring a low oxygen environment).

The dried layer may be calendared, e.g., by using a heavy roller to apply pressure to compress the layer, increasing its density.

The resulting layer may then be sintered by applying heat to the layer to elevate the temperature of the layer above the carbonization threshold of the polymer binder. In some embodiments all or essentially all of the polymer binder is carbonized such that less than 5%, 1%, 0.5%, 0.1%, or less of the layer is polymer binder by weight.

In some embodiments the sintering process is conducted using a laser beam (e.g., a carbon dioxide laser beam) to apply heat to a localized region of the layer to elevate the temperature of that region above the carbonization threshold (the “sintering region”). In some embodiments, the laser beam may be scanned across the layer such that the sintering region is moved to successive positions over the area of the layer, e.g., in order to fully carbonize the entire layer. In other words, the sintering process may be conducted in a series of steps where the laser beam traverses the surface of the dried layer from one portion of the dried layer to the next. The entire dried layer is thus sequentially subjected to laser pyrolysis without any intermediate non-sintered (unpyrolyzed) regions.

In various embodiments, the frequency, power, and other parameters of the laser beam may be selected such that the temperature in the sintering region is above the carbonization threshold of the polymer binder, but not so high as to cause damage to the electrode layer or underlying substrate.

In some embodiments, the laser beam may be configured as an elongated sheet running transverse to the major surface of the layer, such that the sintering region has a stripe shape which runs laterally across the layer. In some such embodiments, the layer is advanced (e.g., using a roll to roll process) such that successive portion of the layer move through the laser beam sheet. The speed of advancement may be chosen such that as the layer advances, the portion of the layer downstream from the sintering region is fully carbonized.

In some embodiments, the laser beam may have a depth of focus greater than the thickness of the layer. In some embodiments, the laser beam may have a depth of focus substantially equal to the thickness of the layer. In some embodiments, the laser beam may have a depth of focus in the range of 0.5 to 3.0 times the thickness of the layer, or any subrange thereof.

Exemplary non-limiting embodiments of the foregoing process are set forth in greater detail below (e.g., with reference to FIGS. 1 and 2). A person skilled in the art will recognize that any of the features and techniques described herein may be used alone or in any suitable combination.

For example, in some embodiments, the first and second ball milling steps, the first sintering step and the etching/washing/drying step may be omitted. Instead in some such embodiments, (e.g., as detailed below with reference to FIG. 12) a slurry may be prepared of a solvent, a polymer binder, silicon oxide, and carbonaceous material such as graphite in combination with nanoscopic carbon (e.g., CNTs, graphene, or the like). In some embodiments, this slurry may be prepared using techniques of the types described in U.S. Pat. No. 10,600,582, entitled “Composite Electrode,” issued on Mar. 24, 2020; U.S. Pat. No. 9,001,495, entitled “High power and high energy electrodes using carbon nanotubes,” issued on Apr. 7, 2015 and also U.S. Pat. No. 9,218,917, entitled “Energy storage media for ultracapacitors,” issued on Dec. 22, 2015. After preparation of this slurry, the process may continue as described above (e.g., including a continuous roll to roll laser carbonization technique).

In other embodiments, the first and second ball milling steps, the first sintering step and the etching/washing/drying step may be omitted. Instead, a slurry may be prepared of a solvent, a polymer binder, nanoscopic carbon shells containing silicon particles (e.g., as described in the '520 patent), and carbonaceous material such as graphite in combination with nanoscopic carbon (e.g., CNTs, graphene, or the like). In some embodiments, this slurry may be prepared using techniques of the type described in U.S. Pat. No. 10,600,582, entitled “Composite Electrode,” issued on Mar. 24, 2020; U.S. Pat. No. 9,001,495, entitled “High power and high energy electrodes using carbon nanotubes,” issued on Apr. 7, 2015 and also U.S. Pat. No. 9,218,917, entitled “Energy storage media for ultracapacitors,” issued on Dec. 22, 2015. After preparation of this slurry, the process may continue as described above (e.g., including a continuous roll to roll laser carbonization technique).

### BRIEF DESCRIPTION OF THE DRAWINGS

A series of micrographs, flow charts and performance graphics are provided and described in greater detail herein.

FIG. 1 is a process flow diagram that details the process steps to produce the composite anode;

FIG. 2 is a process flow diagram that depicts some of the process steps with the photomicrographs of media generated in a particular step;

FIG. 3 depicts one exemplary aspect of sintering processing using laser technology;

FIG. 4 depicts another exemplary aspect of sintering processing using laser technology;

FIG. 5 depicts yet another exemplary aspect of sintering processing using laser technology;

FIG. 6 depicts photomicrographs of a composition prior to laser sintering;

FIG. 7 depicts photomicrographs of the composition of FIG. 7 after laser sintering;

FIG. 8 depicts photomicrographs of another composition after laser sintering;

FIG. 9 depicts graphs of intercalation-deintercalation capacity in a half cell for two different sintered compositions a) 94% silicon, 3% SWCNT and 3% CMC; and b) 83% nSi/PAN, 15% PVP and 2% SWCNT;

FIG. 10 depicts a graph of intercalation-deintercalation capacity in a half cell for a composition comprising nSiE:SW:LiPAA in a weight ratio of 78:2:20;

FIG. 11 is a graph that depicts performance for a pouch cell with symmetric electrodes before and after sintering;

FIG. 12 depicts an exemplary process diagram that includes using a polymeric slurry and lithium salts for producing the composite anode;

FIG. 13 is a photomicrograph depicting compositions that contain silica, graphite, carbon nanotubes and polyvinylpyrrolidone (PVP) before and after laser sintering;

FIG. 14 is a graph that depicts intercalation-deintercalation capacity in a half cell for a composition that comprises silica, graphite, carbon nanotubes and polyvinylpyrrolidone (PVP) before laser sintering;

FIG. 15 is another graph that depicts intercalation-deintercalation capacity in a half cell for the silica, graphite, carbon nanotubes and polyvinylpyrrolidone (PVP) before laser sintering;

FIG. 16 is a graph that depicts intercalation-deintercalation capacity in a half cell for a composition that contains silica, carbon nanotubes and LiPAA before laser sintering;

FIG. 17 is a graph that depicts intercalation-deintercalation capacity in a half cell for the composition of FIG. 14 that comprises silica, graphite, carbon nanotubes and polyvinylpyrollidone (PVP) after laser sintering;

FIG. 18 is a graph that depicts intercalation-deintercalation capacity in a half cell for the composition of FIG. 15 that comprises silica, graphite, carbon nanotubes and polyvinylpyrollidone (PVP) after laser sintering;

FIG. 19 is a graph that depicts intercalation-deintercalation capacity in a half cell for the composition of FIG. 16 that comprises silica, carbon nanotubes and LiPAA after laser sintering;

FIG. 20 is a graph that compares impedance performance for a variety of different compositions;

FIG. 21 is a graph that compares impedance performance for compositions that contain silica and LiPAA;

FIG. 22 is a graph that depicts discharge capacity versus cycle number for a pouch cell;

FIG. 23 is a graph that depicts discharge capacity versus cycle number for a pouch cell;

FIG. 24 is a graph that depicts discharge capacity versus cycle number for a pouch cell;

FIG. 25 is a graph that depicts discharge capacity versus cycle number for a pouch cell;

and

FIG. 26 is a graph that depicts discharge capacity versus cycle number for a pouch cell.

### DETAILED DESCRIPTION OF THE INVENTION

Disclosed herein are techniques for fabrication of an energy storage cell containing silicon containing electrodes. Generally, the techniques include synthesis of silicon containing particles and use of those particles in electrodes. The electrodes are useful in assembly and fabrication of energy storage devices.

It should be recognized that the embodiments set forth herein are merely illustrative and are not limiting of the teachings herein.

In certain embodiments, electrode material as fabricated herein includes a porous base structure that exhibits a high capacity energy storage active material and a shell encapsulating the porous base structure. The shell mechanically constrains the porous base structure and allows passage of ions through the shell during lithiation and delithiation of the active material contained therein. As a result of void spaces within the shell, the shell substantially limits gross swelling of electrodes that contain the active material. That is, swelling as arises from charge cycling of the active material encapsulated within the shell. In certain embodiments, the electrode material composite structure is a part of the negative electrode material or is a negative electrode active material. The high capacity active material may include one or more of the following materials: crystalline silicon, amorphous silicon, silicon oxides, silicon oxynitrides, tin containing materials, sulfur containing materials, and other materials.

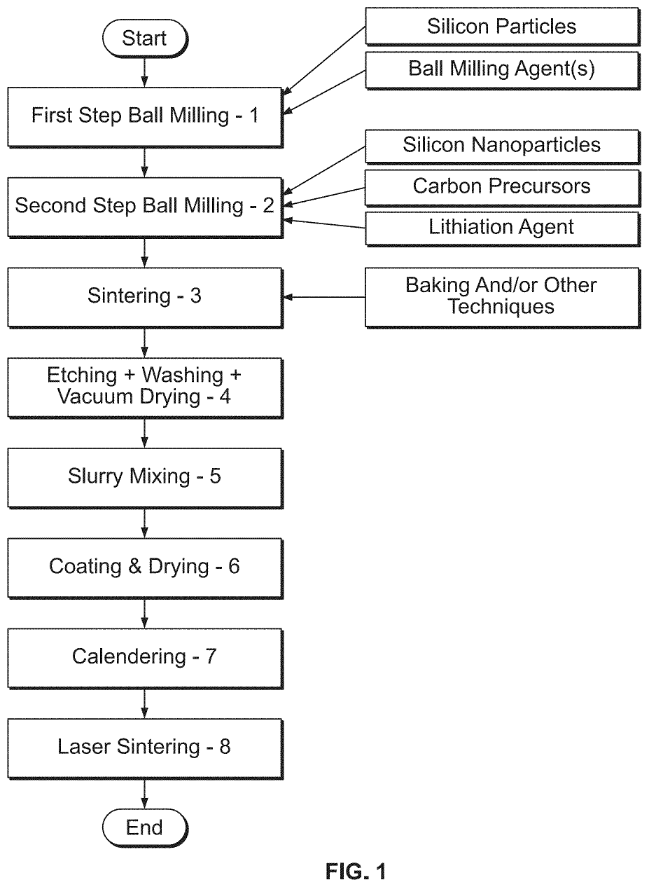

Referring to FIG. 1, a first embodiment begins with two steps of ball milling. In a first step, high energy ball milling of micron-sized silicon particles is performed. The silicon particles are mixed with ball milling agents such as polymer and/or other materials which are provided to assist with breaking the silicon particles into nano-sized silicon powder. In this example, a starting size range of the silicon particles may be from about 2 micrometers (μm) to 20 micrometers (μm) or larger. The charge ratio of milling balls and milling material may range from about 5:1 to 30:1, and the milling time may be in range of 0.1 hours to 24 hours. In some embodiments, the milling time may be in the range of 2 hours to 15 hours. These inputs may be adjusted but provide for silicon nanoparticles ranging in mean diameter of about 80 nanometers (nm) to 500 nanometers (nm).

Ball milling agents may be selected to serve a dual purpose. For example, polymer materials may be selected as a friction modifier to assist with the reduction of the particles into nanoparticles and also as carbon precursors suited for a subsequent sintering process (step 3). Examples of ball milling agents include the polymer materials set forth further herein. Examples of other additives useful as ball milling agents include carbon materials as set forth further herein.

In a second step, the silicon nanoparticles are blended with a carbon precursor by way of dry mixing or using a liquid sol-gel reaction and further milled. An optional lithiation agent may be included in the mixture of silicon nanoparticles and carbon precursor. Examples of carbon precursors include selected ball milling agents as well as some of the organic materials identified further herein. Examples of lithiation agents that may be added to the mixture include lithium hydroxide (LiOH), another is lithium borohydride (LiBH₄), a further example is lithium phosphorous oxynitride (LiPON). This results in blended material which is subjected to heat treatment in a third step.

In the third step, the blended material is subjected to heat treatment. Heat treatment may by any technique such as baking in an oven, laser heating or by other techniques. Generally, the blended material is subjected to heating to make the blended material coalesce into a solid or porous mass without liquification (through a process commonly known as sintering). In this example, the blended material is processed with high temperature sintering to form a carbon matrix that includes carbon coated silicon nanoclusters. In some embodiments, a ratio between the silicon material and carbon precursor ranges from about 9:1 to 5:5. The temperature for sintering may be from about 300 degrees Celsius to 1200 degrees Celsius and in some embodiments, from 600 degrees Celsius to 1000 degrees Celsius. Sintering may be in an inert atmosphere for between about two hours to six hours. The inert atmosphere may include, for example, nitrogen, argon, hydrogen, or other gases and mixtures thereof. Ranges selected may depend on, among other things, the nature of the carbon precursor selected, mix ratios and other such factors. The heat treatment process (sintering, in this example), results in a plurality of carbon coated silicon nanoclusters.

In a fourth step, the resulting carbon coated silicon nanoclusters are then treated with an etchant, such as an alkaline etchant, to create engineered voids inside the silicon nanoclusters. In some embodiments, the etchants used strongly basic. For example, the etchant may be sodium hydroxide (NaOH) or potassium hydroxide (KOH), with concentration ranging from about 0.5M to 1.0M. An effective etching temperature may be from about fifty degrees Celsius to eighty degrees Celsius. Aspects such as etchant selected, duration, molarity and temperature may be varied to control attributes of void space created in the carbon coated silicon nanoclusters. After etching, the etched nanoclusters are substantially in powder form. The etched nanocluster powder may then be collected, washed and dried before preparing into electrode slurry.

In this example, a thickness of the carbon coating on the etched nanoclusters is between about two nanometers (nm) to ten nanometers (nm). A volume of the void space created within the etched nanoclusters ranges from about ten percent to fifty percent of the total volume. The resulting etched nanocluster powder may be referred to herein as a “silicon based active material.”

The surface of the etched nanoclusters may be further modified through introduction of, for example, conductive carbon materials, such as single-walled carbon nanotubes, multiwalled carbon nanotubes, carbon nanofiber, carbon microfiber, graphite, and graphite oxide. The carbon materials can be made adhered to the surface of the etched nanoclusters through a combination of processing techniques, including but not limited to chemical self-assembly through surfactants and physical dry/spray-drying process.

In a fifth step of the electrode preparation process, mixing of a slurry with the silicon based active material is undertaken. In slurry mixing, the silicon based active material is mixed with electrically conductive carbon material and polymer binder in a solvent such as water, alcohol, other solvents and combinations thereof. The water may be deionized water (DI). The carbon material may include single walled carbon nanotubes (SWCNT), multiwalled carbon nanotubes (MWCNT), carbon nanofiber (CNF), carbon microfiber (CMF), graphite, graphene, graphene oxide, hard carbon, soft carbon, and the amount in range of 0.05 weight percent (wt %) to 50 weight percent (wt %), while the polymer binder amount may be in the range of five weight percent (wt %) to thirty weight percent (wt %), with slurry solid content ranges from fifteen weight percent (wt %) to sixty five weight percent (wt %). Viscosity of the slurry may range from about 2000 mPa·s to about 20000 mPa·s. In general, the carbon material may be provided as high aspect ratio carbon materials. The carbon materials are dispersed in such a way as to create a network that will serve as a scaffold after a carbonization step.

In a sixth step, the slurry mixture is applied to a conductor layer. The conductor layer may be referred to as a current collector. The conductor layer may be a film or foil made of aluminum or copper. The conductor layer may have surface treatment intended to encourage adhesion of the slurry mixture.

Electrode material is obtained by applying the slurry to the conductor layer. Conventional techniques may be used for coating the conductor layer. Examples include coating with a doctor blade, roll-to-roll processing and others. Subsequently, the electrode material is dried. Drying of the electrode may involve vacuum drying, heat treatment or other techniques.

In a seventh step, dried electrode material may be pressed or “calendered.” Pressure applied in the calendaring step may range from about 1 ton/cm² to 10 ton/cm². The electrode after calendaring may exhibit press density in a range from about 0.6 g/cm² to 1.8 g/cm³. The dried electrode material may be further treated with heat to cause sintering, e.g., sintering using laser processing. Laser processing may be configured to convert the binder generally made of carbon precursor into a carbon matrix that embeds the active material. The carbon yield of the carbon precursor may be from 12 percent to 60 percent, while the final porosity of the silicon containing electrode may range between about 10 percent to 70 percent, with a mass ratio of silicon to carbon of between about 1:10 to 10:1. In some embodiments, following the sintering process the electrode layer may have a greatly reduced amount of polymeric material, or may even be essentially free of polymeric material. This advantageously reduces or eliminates unwanted reactions between such polymeric materials and electrolyte during the operation of an electrochemical cell incorporating the electrode.

Generally, whether provided as a ball milling agent or a carbon precursor, at least some of the carbon materials used are high aspect ratio nanocarbon materials. In some embodiments, the high aspect ratio nanocarbons need not be uniform or substantially uniform. A series of long (“dominant,” “major” or other terminology may be used as well) high aspect ratio nanocarbons collectively provide a scaffold (or “framework”) for a carbon network and a series of short (also referred to as “minor” or other similar terminology may be used) high aspect ratio nanocarbons serve as ties within the carbon network. In some embodiments, high aspect ratio carbons may include carbon having one major dimension that is significantly longer than two minor dimensions, as is the case with carbon nanotubes, carbon fibers, carbon nanorods, and elongated bundles of the foregoing. For example, in some embodiments, the major dimension may be at least 10, 100, 1,000, 10,000, or more times the two minor dimension. In some embodiments, high aspect ratio carbon also includes carbon having two major dimensions that are significantly longer than a minor dimension, as is the case with graphene flakes and the like. For example, in some embodiments, the major dimensions may each be at least 10, 100, 1,000, 10,000, or more times the minor dimension.

Additionally, the carbon network may include shaped carbon structures as couplers. Generally, the term “shaped carbon structures” refers to carbon additions that are not high aspect ratio nanocarbons, e.g., carbon nanohorns, nanoflowers, nano- or meso-scopic carbon particles or clusters, and the like. Generally, the couplers enhance the integrity of the carbon network as well as retention of the active materials. In addition to the aforementioned carbon framework, two dimensional carbon materials such a graphene, graphene nanoplatelets, and graphene oxide may be used to within the framework to provide increased mechanical and electrochemical properties of the resulting electrode.

Generally, the carbon network may contain carbon nanotubes (CNT). The carbon nanotubes (CNT) may be single walled (SWNT), multi-walled (MWNT) or some combination thereof. The carbon nanotubes (CNT) may be open-ended, capped or a combination thereof. In some embodiments, the average length of the carbon nanotubes (CNT) in the carbon network may be at least 0.1 micrometers (μm), 0.5 micrometers (μm), 1 micrometers (μm), 5 micrometers (μm), 10 micrometers (μm), 50 micrometers (μm), 100 micrometers (μm), 200 micrometers (μm), 300, micrometers (μm), 400 micrometers (μm), 500 micrometers (μm), 600 micrometers (μm), 7000 micrometers (μm), 800 micrometers (μm), 900 micrometers (μm), 1,000 micrometers (μm) or more. For example, in some embodiments, the average length of the carbon nanotubes (CNT) may be in the range of 1 micrometer (μm) to 1,000 micrometers (μm), or any subrange thereof, such as 1 micrometer (μm) to 600 micrometers (μm). In some embodiments, more than fifty percent (50%), sixty percent (60%), seventy percent (70%), eighty percent (80%), ninety percent (90%), ninety five percent (95%), ninety nine percent (99%) or more of the carbon nanotubes (CNT) may have a length within ten percent of the average length (10%) of the carbon nanotubes (CNT) in the carbon network.

Other forms of carbon that may be used in the carbon network to provide at least one of the scaffold and the ties include carbon nanofiber (CNF), carbon microfiber (CMF), reduced graphene oxide (RG) and graphene oxide (GO). Generally, carbon nanofibers (CNFs) may include vapor grown carbon fibers (VGCFs), or vapor grown carbon nanofibers (VGCNFs) and are generally cylindrical nanostructures with graphene layers arranged as stacked cones, cups or plates. Carbon nanofibers with graphene layers wrapped into perfect cylinders are carbon nanotubes (CNT). Carbon microfibers (or simply, carbon fibers, which may also be referred to as graphite fiber) include fibers about of about 5 micrometers (μm) to 10 micrometers (μm) in diameter and composed mostly of carbon atoms. The carbon fibers may have diameters ranging from about 16 micrometers (μm) to 22 micrometers (μm).

Graphene, graphene nanoplatelets, and graphene oxide are generally 2D nanostructures composed of single layer or stacked multilayers of graphene sheets (highly functionalized graphene sheets, in the case of graphene oxide) ranging from 0.5 um to 200 um in diameter. Generally, the atomic structure of carbon fiber is similar to that of graphite, consisting of sheets of carbon atoms arranged in a regular hexagonal pattern (graphene sheets), the difference being in the way these sheets interlock.

Depending upon the precursor to make the fiber, carbon fiber may be turbostratic or graphitic, or have a hybrid structure with both graphitic and turbostratic parts present. In turbostratic carbon fiber the sheets of carbon atoms are haphazardly folded, or crumpled, together. Carbon fibers derived from polyacrylonitrile (PAN) are turbostratic, whereas carbon fibers derived from mesophase pitch are graphitic after heat treatment at temperatures exceeding 2200° C. Turbostratic carbon fibers tend to have high tensile strength, whereas heat-treated mesophase-pitch-derived carbon fibers have high Young's modulus (i.e., high stiffness or resistance to extension under load) and high thermal conductivity.

In various embodiments, the shaped carbon structures can include carbon in a variety forms, including activated carbon, carbon black, graphite, and others. The shaped carbon structures can include carbon particles, including nanoparticles, such as nanotubes, nanorods, graphene in sheet, flake, or curved flake form, and/or formed into cones, rods, spheres (buckyballs) and the like.

Generally, the carbonaceous materials selected for the carbon network may have a surface that is at least partially “functionalized.” That is, the carbonaceous materials used undergo surface functionalization using, for example, carboxylic (COOH) groups, amine (NH₂) groups, silane groups or other materials. Generally, the functionalized carbon materials may develop a covalent linkage to active material particles, e.g. amine linkage, in this case, particles of silicon based active material.

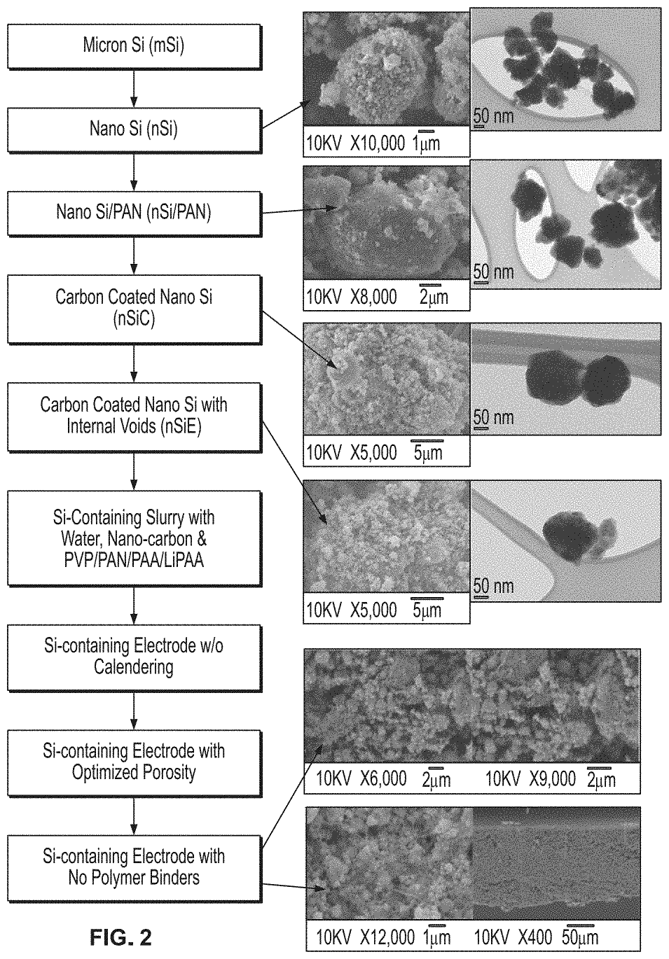

An overview of the above process is set forth in FIG. 1. FIG. 2 depicts aspects of the media as it is processed in the steps set forth in FIG. 1.

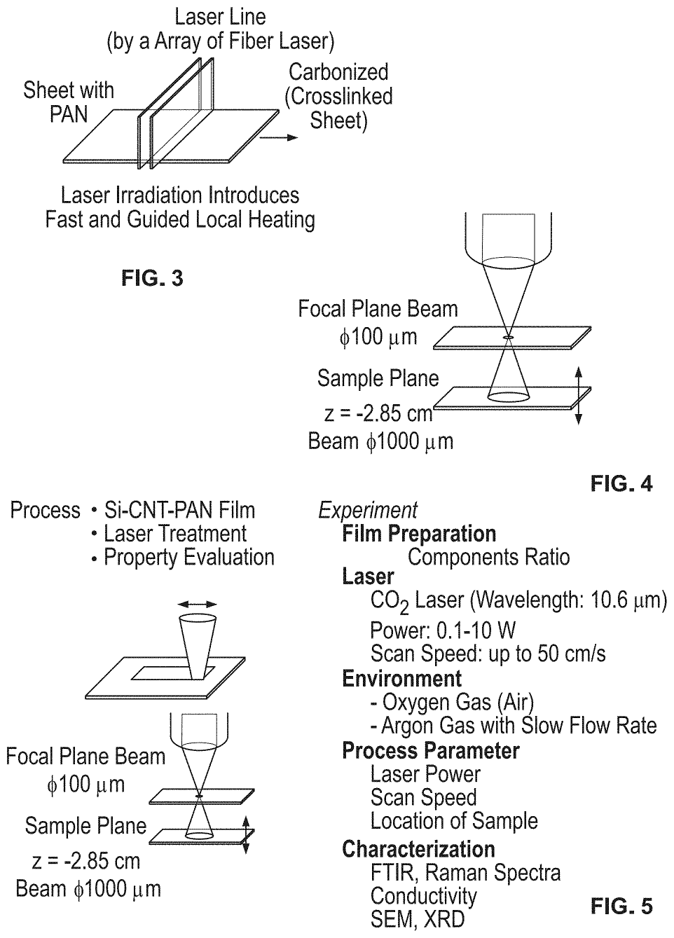

FIG. 3 through FIG. 5 depicts aspects of sintering processing using laser technology. In addition to that which is shown, other technologies may be incorporated into laser sintering. For example, sensors may be employed to monitor product quality and adjust processing. One example includes machine vision for monitoring aspects such as surface quality. Other sensors may use, for example, interrogation with wavelengths to detect presence and/or quantity of residual carbon precursors. The sensors may be used to provide input to a control system which may then modulate, for example, production speed, laser power, and other such parameters.

It should be noted that in some other embodiments, some materials may be useful for providing a binding function while fabricating electrodes while subsequently being converted to carbon during assembly and thus becoming additional carbonaceous material within the energy storage media. Processes for conversion of such “assembly agents” include pyrolysis, among others. One example of an assembly agent is polyvinylpyrrolidone (PVP).

Examples of carbon precursors include polymeric binders/fibers (Polyacrylonitrile/PAN, PVP, PAA, carboxymethylcellulose (CMC), or LiPAA, and the like.). These and/or other materials may be used to result in carbonization and graphitization of the polymer binders/fibers.

Polyacrylonitrile (PAN), also known as “polyvinyl cyanide,” is a synthetic, semicrystalline organic polymer resin, with the linear formula (C3H3N)ₙ. Almost all PAN resins are copolymers made from mixtures of monomers with acrylonitrile as the main monomer. PAN is a versatile polymer used to produce large variety of products including membranes, hollow fibers, and solid fibers. PAN fibers are the chemical precursor of high-quality carbon fiber. PAN is first thermally oxidized in air at 230 degrees Celsius to form an oxidized PAN fiber and then carbonized above 1000 degrees Celsius in inert atmosphere to make carbon fibers. Other similar materials may be used. As noted above, these may include the non-limiting examples of PVP, PAA or (lithium polyacrylate) LiPAA. Polyvinylpyrrolidone (PVP), also commonly called polyvidone or povidone, is a water-soluble polymer made from the monomer N-vinylpyrrolidone. Phenylacetic acid (PAA; conjugate base phenylacetate), also known by various synonyms, is an organic compound containing a phenyl functional group and a carboxylic acid functional group. Further examples of carbon precursors include, without limitation, PANI(polyaniline), PEDOT(poly(3,4-ethylenedioxythiophene), PSS(poly(styrene-4-sulfonate), PI(polyimide)/PAA(Polyamic acid), sugars, sucrose, citric acid, metallic silicon of various sizes (nano to micron scale, silicon oxide, off the shelf commercial silicon oxide. Combinations of materials may be used.

The laser processing may be used in large volume roll-to-roll manufacturing and support high-speed electrode manufacturing processing. Laser processing provides for roll-to-roll continuous process with carbonization of polymeric phases contained within an electrode. As shown in FIGS. 3 through 5, a linear array of laser may be used where the sheet of electrode is moved at an appropriate speed through the laser field in order to carry out the carbonization through heat introduced by the laser. In some embodiments, laser processing is performed in-line with calendaring or other manufacturing steps.

Heating with the laser may be adjusted through a variety of techniques. For example, the scan rate/dwell time of the laser may be varied. The relationship of the laser and sample (e.g., distance, angle of incidence) may be varied. Wavelengths may be varied. Atmospheric controls, such as supplying treatment area gas (e.g., nitrogen gas or argon gas) to control reactions may be used. Processing of the sample may be slowed with the addition of an idler loop in the roll-to-roll process. In short, a variety of techniques may be employed to control finish quality.

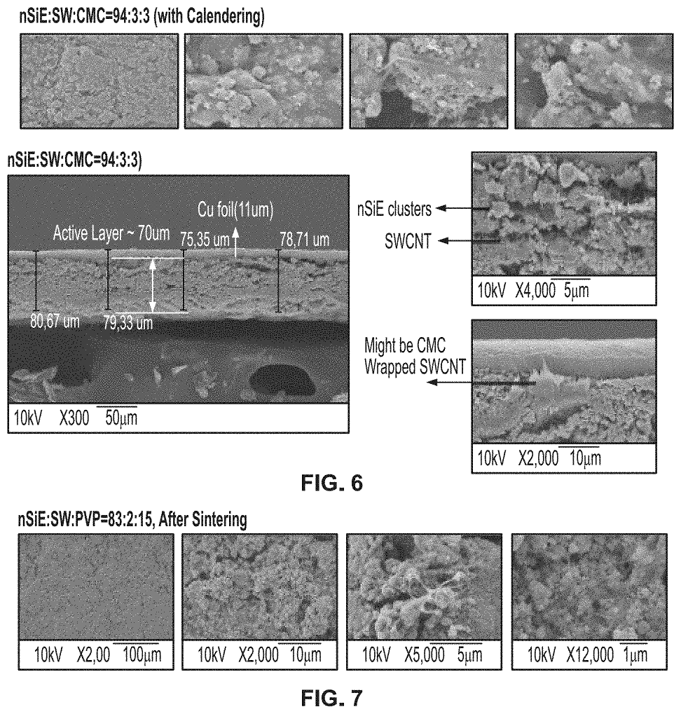

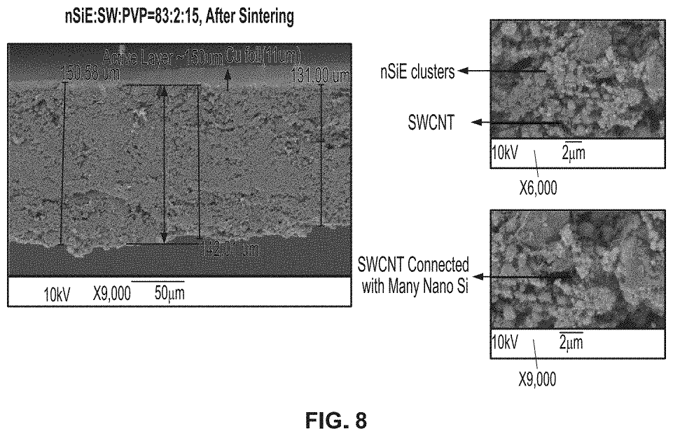

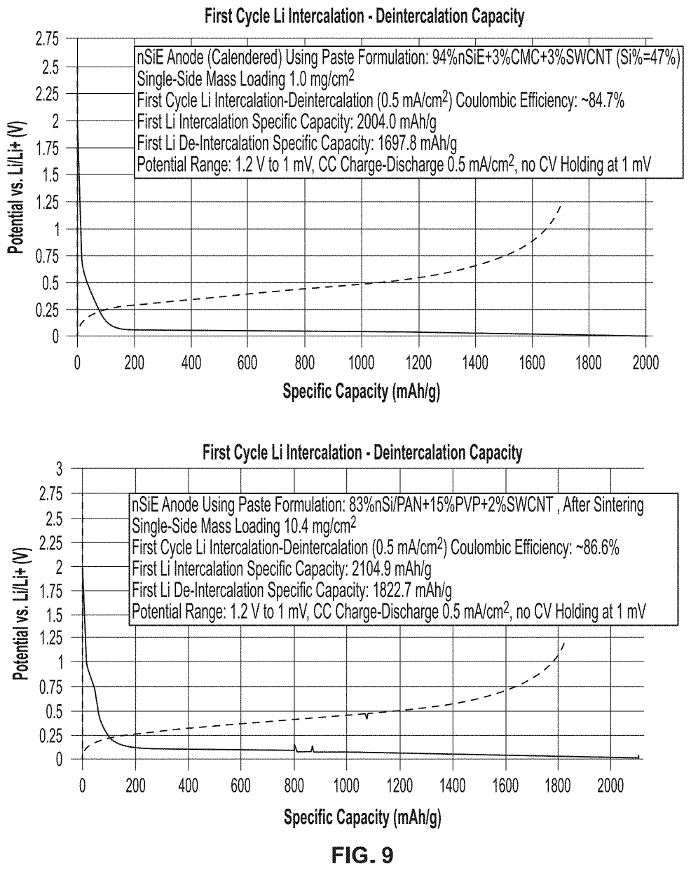

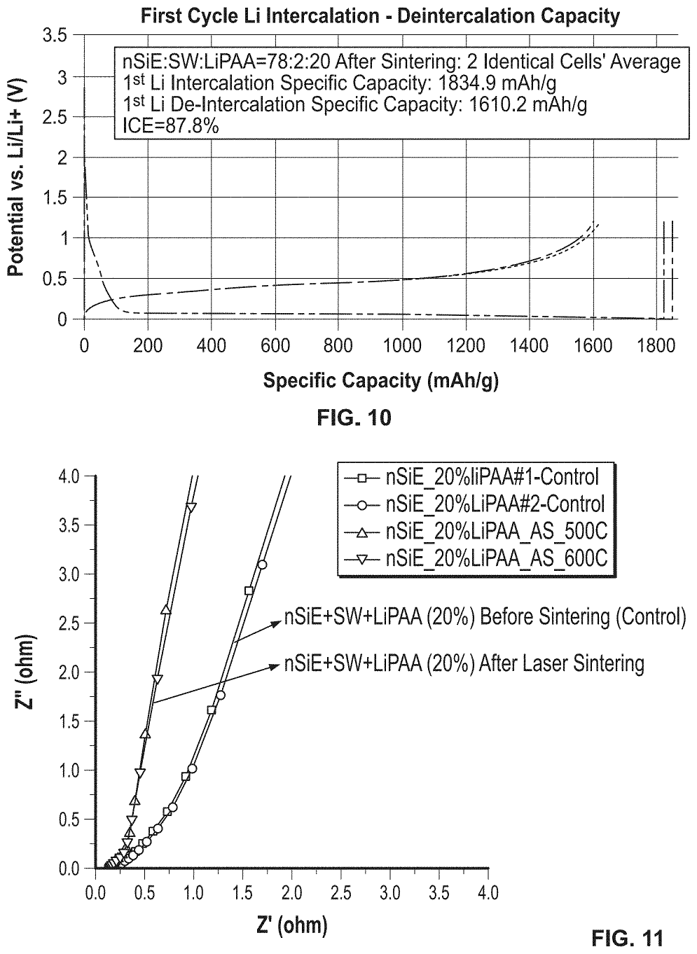

FIG. 6 through FIG. 8 depict aspects of materials produced and performance of a test cell. The test cell was a half coin cell with a silicon anode electrode, and the counter electrode was Li foil. The separator was a glass fiber-based separator and the electrolyte was a Li-ion based carbonate electrolyte. FIG. 6 depicts a CMC control and FIG. 7 shows aspects of the anode fabricated using the process outlined above. FIGS. 8 through 10 are graphs depicting performance of the half cell fabricated according to the techniques set forth in the first embodiment. FIG. 11 depicts performance for a pouch cell with symmetric electrodes. The electrodes used were 35 mm by 35 mm.

Compared with the CMC based control sample, the initial coulombic efficiency (ICE) of the laser sintering Si anode electrode is higher. The highest value achieved in the initial evaluation was about 88% for the first lithium intercalation and de-intercalation cycle.

A Symmetric Pouch Cell test was also conducted. In this test, two identical anodes using the etched silicon clusters disposed in electrodes before (BS, control) and after laser sintering (AS) are assembled with PP based separator and Li-ion based electrolyte. Then an EIS scan was conducted to the symmetric pouch cells from 100 KHz to 0.1 Hz. The active layer size of the electrode was 35×35 mm. As shown in FIG. 11, it can be seen that the electrodes after laser sintering process, the etched silicon cluster anode electrodes display much smaller initial electrical contact resistance and also the charge transfer resistance compared with the control binder-based 20% LiPAA before sintering process. In this example, the anode mass loading was about 10 mg/cm²; the anode porosity was about 35%. The electrolyte used was 1M LiPF6 in EC/DMC+1 wt. % VC. The cell type was a symmetric pouch cell. Evaluations were at a temperature of 25° C.

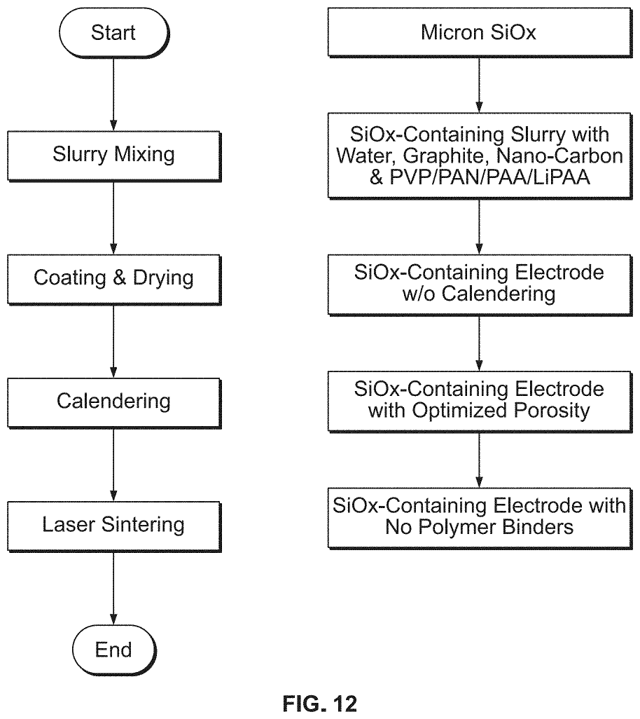

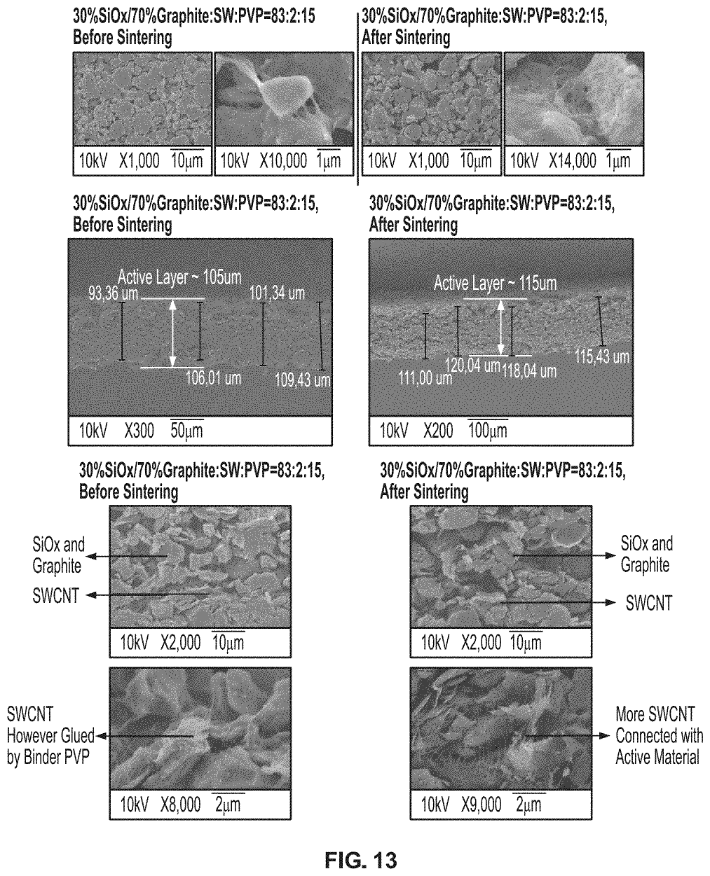

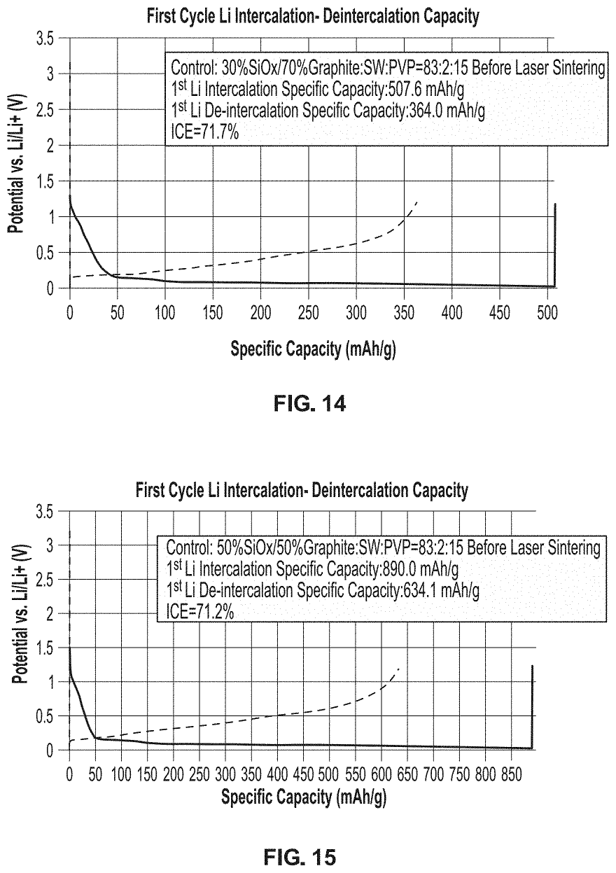

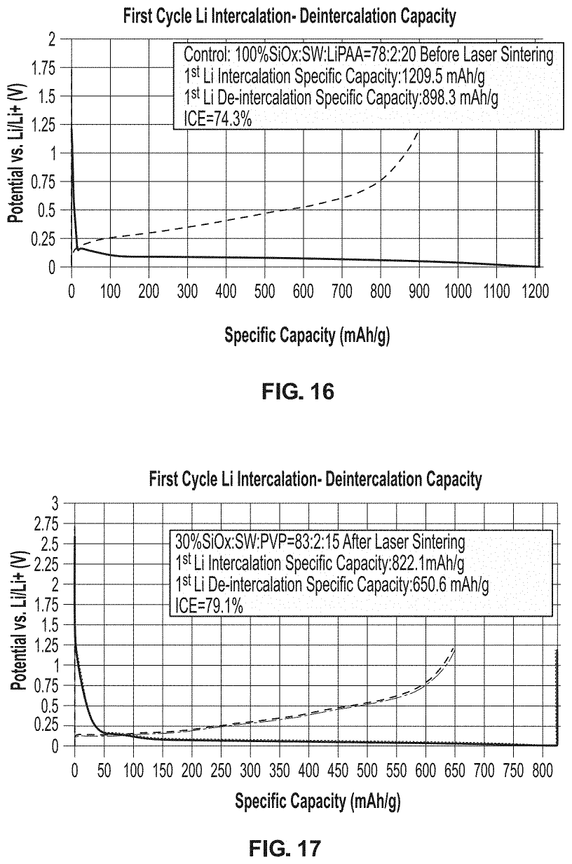

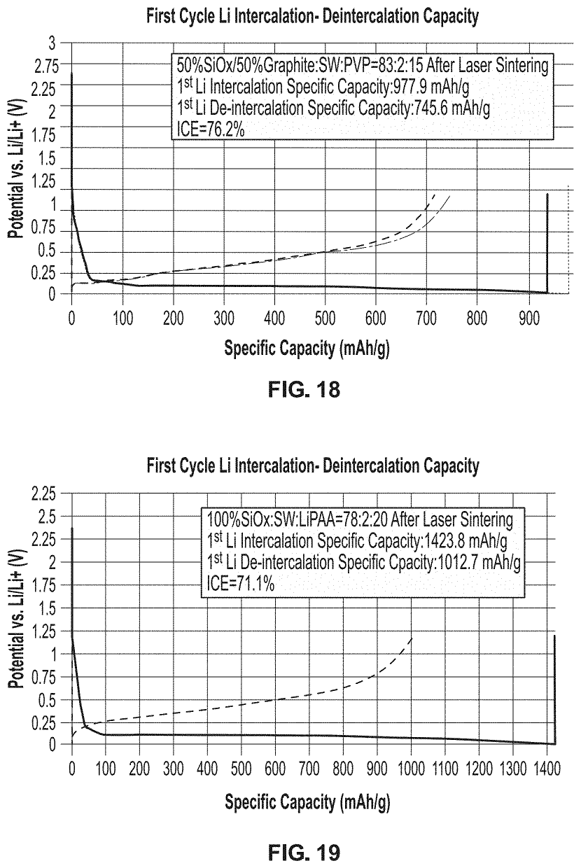

Aspects of a second embodiment are set forth in FIGS. 12 through 21. FIG. 12 is a flow chart that sets forth variations in the first embodiment above. In this example, silicon oxide (SiOₓ)(where x=1 to 2 including non-integers) particles are formed. Before laser sintering, the nano-carbon and SiOx and graphite particles were mostly glued by the polymer binder PVP, while after laser sintering, PVP was removed from SWCNT, thus more bonding and electrical contacts in between particles as shown in the SEM images of FIG. 13. FIGS. 14 through 21 are graphs setting forth performance data.

Again, the materials produced were used to fabricate a test cell. The test cell was a half coin cell with a silicon anode electrode, and the counter electrode was Li foil. The separator was a glass fiber based separator and the electrolyte was a Li-ion based carbonate electrolyte. A control sample was a binder-based SiOₓ containing electrode before sintering (See FIGS. 14, 15, 16). Comparative performance of SiOₓ containing anode electrodes based on the second embodiment for fabrication (FIG. 12) is set forth in FIGS. 17, 18 and 19.

Compared with the PVP based control sample, the initial coulombic efficiency (ICE) of the laser sintering 30% SiOx and 50% SiOx anode electrode is much higher than the binder-based SiOx containing anode electrodes for the first lithium intercalation and de-intercalation cycle. Also after the laser sintering, the SiOx anode electrode specific capacity in mAh/g is also much higher. For the LiPAA, after laser sintering, the 100% SiOx can achieve a much higher specific capacity in mAh/g. It was noted that the ICE is 1.5% lower than the SiOx before sintering, but it is comparable to the 20% LiPAA binder-based control SiOx anode electrodes.

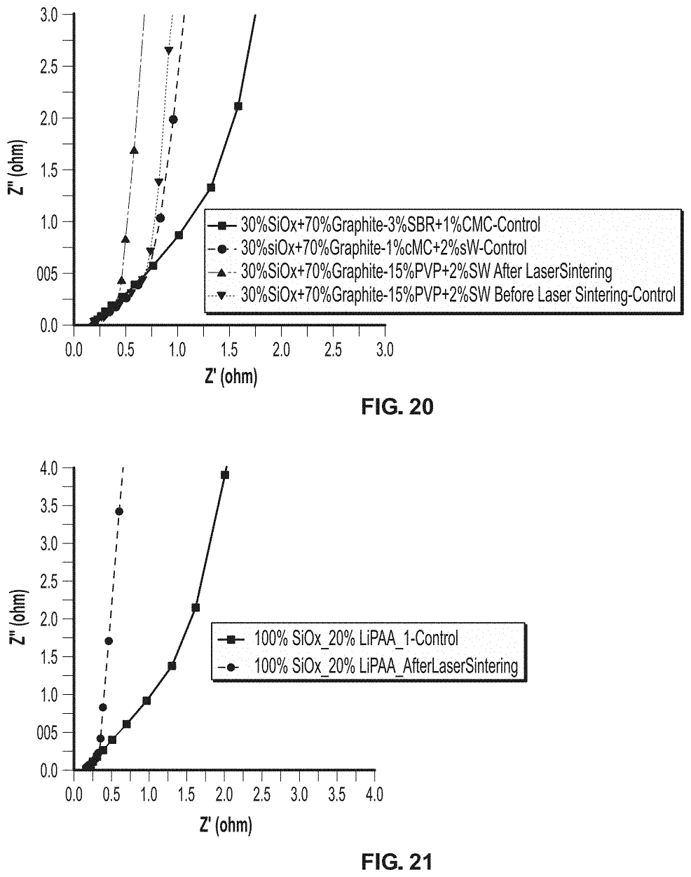

Aspects of a further comparison are set forth in FIGS. 20 and 21. In this comparison, a symmetric pouch cell EIS test was performed. Two identical SiOx containing anode electrodes were fabricated: before sintering (BS, control) and after laser sintering (AS). A PP based separator was used along with Li-ion based electrolyte. Then an Electrochemical Impedance Spectroscopy, (EIS) scan was conducted for the symmetric pouch cells from 100 KHz to 0.1 Hz. The size of the electrode active layer size was 35×35 mm. As shown in FIGS. 20 and 21, electrodes after laser sintering process, the SiOx containing anode electrodes display much smaller initial electrical contact resistance and also the charge transfer resistance compared with the control PVP or LiPAA binder-based before sintering process. In this example, the mass loading of the anode was about 10 mg/cm². Porosity of the anode was about 35%. The electrolyte used was 1M LiPF6 in EC/DMC+1 wt. % VC. The cell type was a symmetric pouch cell. Temperature for the analyses was 25° C.

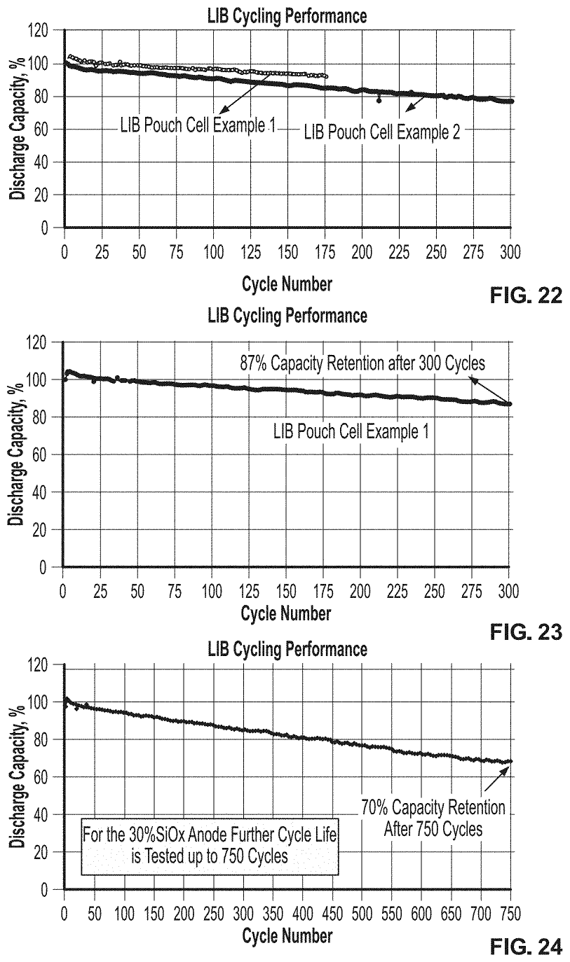

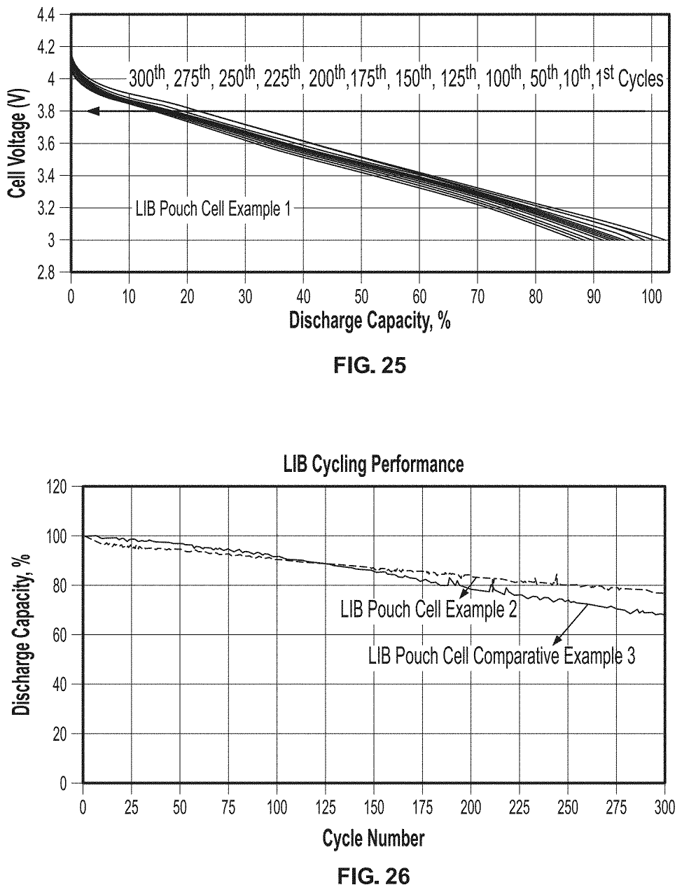

In a third embodiment, a full cell Li-ion battery was fabricated. The cell was based on a polymer binder-free NMC811 cathode and Si/SiOx-containing anode. Pre-lithiation of the anode was undertaken using ultra-thin lithium. Aspects of performance are depicted in FIGS. 22 through 25.

Generally, the cathode may include a variety of active materials. For example, the cathode may include NMC811, NMC622, NMC532, LCO, LFP, NCA etc. In some embodiments, the active materials are disposed in a carbon network that is without any polymer binder. Active material may range from about 80 weight percent to about 99.5 weight percent. Nanocarbon in the carbon network may range from about is from 0.5 weight percent to about 20 weight percent. The porosity may range from about 10 percent to 70 percent. The thickness of the active layer for a single-side electrode may range from about 5 micrometers (μm) to about 300 micrometers (μm). Single-side mass loading may range from about 2 mg/cm² to 80 mg/cm². In the embodiments tested, the current collector was aluminum foil.

The anode electrodes included SiOx and etched silicon nanocluster materials without any polymer binder. Anodes constructed were based on above Si-containing electrode fabrication processes (the first embodiment for the etched silicon nanocluster materials and the second embodiment for SiOₓ materials). The active materials ranged from about 80 weight percent to about 99.5 weight percent. Nanocarbon in the carbon network may range from about is from 0.5 weight percent to about 20 weight percent. The porosity may range from about 10 percent to 70 percent. The thickness of the active layer for a single-side electrode may range from about 5 micrometers (μm) to about 300 micrometers (μm). Single-side mass loading may range from about 2 mg/cm² to 80 mg/cm². In the embodiments tested, the current collector was aluminum foil. The mass ratio in the active material for Si:Carbon was between about 1:10 to 10:1. In the embodiments tested, the current collector was copper foil.

Pre-lithiation of the anode was undertaken using ultra-thin Li film (uLi). The uLi film was pressed onto the anode electrode surface to pre-dope lithium source into the Si-containing anode electrodes after electrolyte filling process. The thickness of the lithium film ranged from about 2 micrometers (μm) to 45 micrometers (μm). The pre-doping anode electrode initial Li-intercalation capacity % by the uLi is from 5% to 50%. The capacity ratio between anode (negative) (after pre-lithiation by uLi) and cathode (positive) electrode (N/P Ratio) was from 1.1 to 3.

The electrolyte used included FEC containing carbonate/ether/ionic liquid organic electrolyte with either 1.0-1.2 M LiPF6 or LiFSI as main salt with other additives including VC, LiBOB, LiDFOB, LiDFOP, LiFSI, LiTFSI, LiBETI, pyrocarbonate, DTD. The separator materials included PP, PE, Cellulose, or hybrid PP/PE/Cellulose material.

Three energy storage cells were fabricated to evaluate performance. Examples 1 and 2 below were fabricated according to the teachings herein. Example 3 was fabricated using conventional techniques that included binder materials with the active media.

Example 1 of Li-ion Battery Pouch Cell included: active material in the cathode was polymer binder-free NMC811. Mass loading was about 22 mg/cm², porosity was 25 percent. The NMC811 active material % was 97 weight percent and the portion of nanocarbon was 3 weight percent. The current collector was aluminum foil.

Active material in the anode included polymer binder-free 30% SiOx. The anode materials were based on the Si-containing anode electrode fabrication of the second embodiment above (see FIG. 12). Mass loading was about 9 mg/cm², porosity was 35%. The Si:Carbon content mass ratio was 3:7. The current collector was copper foil. The N/P Ratio was 1.3. The electrolyte used was FEC containing carbonate liquid organic electrolyte with LiPF6 salt with other additives. The cell type was a pouch cell rated for output of about 100 mAh. The anode initial Li-intercalation pre-lithiation capacity by uLi was 29.2 percent. The 50 Ah cell energy density calculation by this cell design estimated gravimetric power density of 342 Wh/kg and volumetric power density of 1007 Wh/L.

Example 2 of Li-ion Battery Pouch Cell included active material in the cathode was polymer binder-free NMC811. Mass loading was about 24 mg/cm², porosity was 25 percent. The NMC811 active material % was 97 weight percent and the portion of nanocarbon was 3 weight percent. The current collector was aluminum foil.

Active material in the anode included polymer binder-free 100% SiOx. The anode materials were based on the Si-containing anode electrode fabrication of the second embodiment above (see FIG. 12). Mass loading was about 4 mg/cm², porosity was 35%. The Si:Carbon content mass ratio was 10:1. The current collector was copper foil. The N/P Ratio was 1.4. The electrolyte used was FEC containing carbonate liquid organic electrolyte with LiPF6 salt with other additives. The cell type was a pouch cell rated for output of about 100 mAh. Anode initial Li-intercalation pre-lithiation capacity by uLi was 32.9 percent. The 50 Ah cell energy density calculation by this cell design estimated gravimetric power density of 390 Wh/kg and volumetric power density of 1245 Wh/L.

Example 3 of a Li-ion Battery Pouch Cell included a cathode with active material containing binder as a control for comparison with Examples 1 and 2. Mass loading was about 24 mg/cm², porosity was 25 percent. The NMC811 active material % was 97 weight percent and the portion of nanocarbon was 3 weight percent. The current collector was aluminum foil.

Active material in the anode included 100% SiOx with polymer (10% LiPAA+1% CMC binder-based). The anode materials were based on the Si-containing anode electrode fabrication of the second embodiment above (see FIG. 12). Mass loading was about 4 mg/cm², porosity was 35%. The Si:Carbon content mass ratio was 10:1. The current collector was copper foil. The N/P Ratio was 1.4. The electrolyte used was FEC containing carbonate liquid organic electrolyte with LiPF6 salt with other additives. The cell type was a pouch cell rated for output of about 100 mAh. Anode initial Li-intercalation pre-lithiation capacity by uLi was 32.9 percent. The 50 Ah cell energy density calculation by this cell design estimated gravimetric power density of 390 Wh/kg and volumetric power density of 1245 Wh/L.

For each of the foregoing examples, cycle life data comparison is shown in FIGS. 22 through 26. All of the pouch cell examples are charged-discharged from 4.2 to 3.0 V under 0.5 C-Rate constant current and constant voltage (CCCV) charge and 1 C-Rate CC discharge. The graphics show that for this cell design, the cycling performance data for embodiments without binder, (Example 1 and Example 2) is superior to the comparative binder-based SiOx anode electrodes (Example 3).

Any terms of orientation provided herein are merely for purposes of introduction and are not limiting of the invention. For example, a “top” layer may also be referred to as a second layer, the “bottom” layer may also be referred to as a first layer. Other nomenclature and arrangements may be used without limitation of the teachings herein. The term “exemplary” as used herein is to indicate one of many possible examples, and is not to be construed as a superlative

Various other components may be included and called upon for providing for aspects of the teachings herein. For example, additional materials, combinations of materials and/or omission of materials may be used to provide for added embodiments that are within the scope of the teachings herein.

A variety of modifications of the teachings herein may be realized. Generally, modifications may be designed according to the needs of a user, designer, manufacturer or other similarly interested party. The modifications may be intended to meet a particular standard of performance considered important by that party. Similarly, acceptability of performance is to be assessed by the appropriate user, designer, manufacturer or other similarly interested party.

While some chemicals may be listed herein as providing a certain function, a given chemical may be useful for another purpose.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. As used herein, the term “exemplary” is not intended to imply a superlative example. Rather, “exemplary” refers to an embodiment that is one of many possible embodiments.

The entire contents of each of the publications and patent applications mentioned above are incorporate herein by reference. In the event that the any of the cited documents conflicts with the present disclosure, the present disclosure shall control.

Note that it is not intended that any functional language used in claims appended herein be construed as invoking 35 U.S.C. § 112(f) interpretations as “means-plus-function” language unless specifically expressed as such by use of the words “means for” or “steps for” within the respective claim.

While the invention has been described with reference to exemplary embodiments, it will be understood that various changes may be made and equivalents may be substituted for elements thereof without departing from the scope of the invention. For example, in some embodiments, one of the foregoing layers may include a plurality of layers there within. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A composition comprising:
a shell that is substantially carbon encapsulating a volume that contains a nanoform of silicon and a void space.

2. A method of fabricating a composition comprising:
combining a nanoform of silicon with a carbon precursor and sintering the combination with a laser.

3. An electrode for an energy storage device comprising:
an encapsulated form of silicon dispersed in a binder-free carbon network and disposed on a current collector.

4. An energy storage device comprising an electrode comprising an encapsulated form of silicon dispersed in a binder-free carbon network and disposed on a current collector.

5. A method of making an electrode for use in an energy storage device comprising:
providing an active material layer comprising silicon and a polymer binder; and
sintering the active material layer to carbonize at least a portion of the polymer binder.

6. The method of claim 5, wherein sintering the active material layer comprises:
applying a laser beam to the active material layer to heat a localized region of the active material layer to carbonize at least a portion of the polymer binder.

7. The method of claim 6, further comprising scanning the laser beam to successive positions on the active material layer.

8. The method of claim 6, wherein applying a laser beam to the active material layer comprises applying a sheet shaped beam, and wherein the localized region comprises a strip across a major surface of the active material layer.

9. The method of claim 8, further comprising advancing the active material layer in a direction transverse to the sheet shaped beam to expose successive regions of the active material layer to the beam.

10. The method of claim 9, wherein advancing the active material layer comprises a continuous roll to role process.

11. The method of claim 6, wherein applying a laser beam to the active material layer to heat a localized region of the active material layer to carbonize at least a portion of the polymer binder comprises controlling the beam to maintain the temperature of in the localized region above the carbonization temperature of the polymer binder, but below a temperature at which the active material or an underlying substrate would be damaged.

12. The method of claim 5, wherein the active material layer contains silicon oxide, and at least one form of nanoscopic carbon.

13. The method of claim 5, wherein providing the active material layer comprises forming a slurry, applying the slurry to form a coating on a substrate.

14. An electrode formed by the process of claim 5.

15. The electrode of claim 14, wherein the active material layer is substantially free of polymer binders.
